(19) United States
(12) Patent Application Publication
(10) Pub. No.: US 2025/0312926 A1
(43) Pub. Date: Oct. 9, 2025

(54) TRANSPORT ROBOT

(71) Applicant: Bear Robotics, Inc., Redwood City, CA (US)

(72) Inventor: Gino NGUEGANG, Belmont, CA (US)

(73) Assignee: Bear Robotics, Inc., Redwood City, CA (US)

(21) Appl. No.: 19/241,055

(22) Filed: Jun. 17, 2025

Related U.S. Application Data
(63) Continuation of application No. PCT/US2022/053766, filed on Dec. 22, 2022.

(51) Int. Cl. B25J 11/00; B25J 13/08; B25J 15/00; B25J 15/06

(52) U.S. Cl. CPC B25J 11/008; B25J 13/08; B25J 15/0019; B25J 15/0608

(57) ABSTRACT

A transport robot is provided. The transport robot includes: a drive unit configured to move the transport robot; a support unit disposed above the drive unit and configured to support a mount target object for accommodating a transport target object; a mount pillar connected to the support unit and configured to include a mount unit including at least one mount member for mounting the mount target object; a hold unit connected to an outer side of the mount pillar to move vertically along the mount pillar, and configured to extend or retract on a plane including travelable directions of the transport robot; and a control unit configured to control the drive unit and the hold unit, wherein the hold unit includes an end effector configured to move toward an inner side or an outer side of the transport robot and hold or release the mount target object.

### CROSS-REFERENCE TO RELATED APPLICATIONS

This application is a continuation of International Application No. PCT/US2022/053766 filed on Dec. 22, 2022, the entire contents of which are herein incorporated by reference.

### FIELD OF THE INVENTION

The present invention relates to a transport robot.

### BACKGROUND

Serving means providing objects including drinks or food to customers in a place such as a restaurant. In recent years, robots and the like have been developed and used for serving in place of, or rendering assistance to, waiters or waitresses. Such a robot usually functions to take food orders or carry out serving according to the orders, and may perform autonomous navigation using table position information or the like. The robot may comprise a transport means (including sensors for avoiding obstacles), a display means for menu output or order input, and the like. Further, the robot may include a means for placing or carrying food or food containers.

As an example of related conventional techniques, Korean Registered Patent Publication No. 10-1083700 discloses a restaurant serving robot system for taking orders in a restaurant and transporting a tray where ordered food is placed, the system comprising: an upper part including a pair of articulated robot arms which are synchronously driven, and a tray holding part rotatably coupled to a lower end of the articulated robot arms and configured to fix the tray; a lower part at a bottom part of which a robot moving part including a main wheel and one or more auxiliary wheels is provided; a middle part fixed to the lower part and rotatably connected to the upper part; and a control part configured to control the operations of the pair of articulated robot arms, the tray holding part, and the robot moving part, wherein the tray holding part comprises: a hand rotatably coupled to an end of the articulated robot arms; a fixing part provided at the hand to move upward and downward; a gripper positioned at a bottom part of the tray and coupled to the fixing part; a stopper positioned at a top part of the tray and coupled to the fixing part to face the gripper; a switch pressed by the fixing part which moves upward when the stopper is pressed by the tray at the same time the end of the articulated robot arms is driven downward; a spring contracted when the fixing part moves upward; and a gripper angle detection unit configured to detect an angle of the gripper.

However, according to the techniques introduced so far as well as the above-described conventional technique, human action is essentially required for a serving robot to achieve its purpose of serving or bussing (i.e., removing a food container). For example, even if the serving robot transports a tray supporting a food container to a table, a person needs to place the tray on the table by picking up the tray and putting it on the table. As another example, even if the serving robot comes to the table to remove the tray, the person needs to pick up the tray and place it in an appropriate position on the serving robot.

In this connection, the inventor(s) present a technique that enables a transport robot to load and unload a mount target object (e.g., a tray or a tub) by itself, so that no or minimal human action is required while the transport robot achieves its purpose (e.g., serving or bussing).

### SUMMARY OF THE INVENTION

One object of the present invention is to solve all the above-described problems in the prior art.

Another object of the invention is to enable a transport robot to load and unload a mount target object by itself.

The representative configurations of the invention to achieve the above objects are described below.

According to one aspect of the invention, there is provided a transport robot, comprising: a drive unit configured to move the transport robot; a support unit disposed above the drive unit and configured to support a mount target object for accommodating a transport target object; a mount pillar connected to the support unit and configured to include a mount unit including at least one mount member for mounting the mount target object; a hold unit connected to an outer side of the mount pillar to move vertically along the mount pillar, and configured to extend or retract on a plane including travelable directions of the transport robot; and a control unit configured to control the drive unit and the hold unit, wherein the hold unit includes an end effector configured to move toward an inner side of the transport robot and hold the mount target object, or to move toward an outer side of the transport robot and release the mount target object.

According to the invention, it is possible to enable a transport robot to load and unload a mount target object by itself.

### BRIEF DESCRIPTION OF THE DRAWINGS

FIG. 1 illustratively shows a transport robot according to a first embodiment of the invention.

FIG. 2 shows a view of the transport robot shown in FIG. 1 as seen from below.

FIG. 3 shows an enlarged view of a part of FIG. 2.

FIG. 4 shows an enlarged view of a part of FIG. 3.

FIG. 5 illustratively shows a view in which the transport robot according to the first embodiment of the invention unloads a mount target object.

FIG. 6 illustratively shows a transport robot according to a second embodiment of the invention.

FIG. 7 illustratively shows a support unit of the transport robot according to the second embodiment of the invention.

FIG. 8 illustratively shows a mount unit of the transport robot according to the second embodiment of the invention.

FIG. 9 illustratively shows a view in which a transport robot unloads or loads a mount target object to or from a shelf.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

Meanwhile, although the cases where a transport robot is used in a restaurant will be mainly described herein, the present invention is not necessarily applicable only to the robot used in the restaurant. It should be understood that the present invention is applicable to a robot used in any other type of place (e.g., an office or a warehouse) as long as a mount target object is loaded/unloaded in a manner similar to the various embodiments described herein.

### First Embodiment

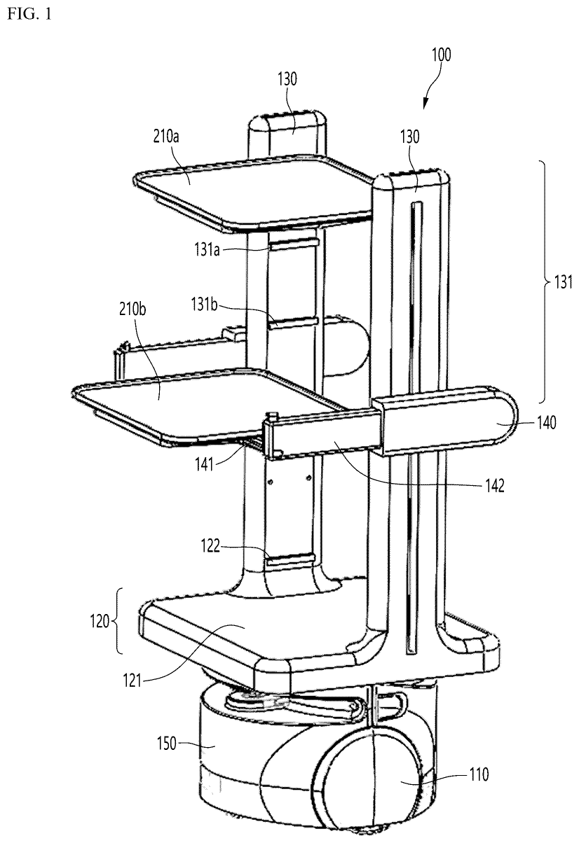

FIG. 1 illustratively shows a transport robot 100 according to a first embodiment of the invention. The transport robot 100 may be implemented as a robot in the same manner as a conventional robot, but may also be implemented as a transport cart or the like having more traditional drive and control means, or as a transport drone or the like having flight means.

The component indicated by reference numeral 110 in FIG. 1 is a drive unit configured to move the transport robot 100. The drive unit 110 may include an electric motor powered by a rechargeable battery, a wheel driven by the electric motor, a steering means of the wheel, and the like. The wheel of the drive unit 110 may be covered by a housing as much as possible so as not to be outwardly exposed.

A support unit 120 configured to support a mount target object 210a or 210b for accommodating a transport target object (e.g., a food container) may be disposed above the drive unit 110. The support unit 120 may include at least one of a support plate 121 and a support member 122.

A recognition unit (not shown) may be configured to recognize whether the mount target object 210a or 210b is placed on the support unit 120, specifically any one of the support plate 121 and the support member 122. For example, the recognition unit may recognize whether the mount target object 210a or 210b is placed on the support unit 120, specifically any one of the support plate 121 and the support member 122, using an image acquisition module (e.g., a visible light camera or an infrared camera), a scanner module (e.g., a LIDAR sensor), a weight (or pressure) sensor, a touch sensor (e.g., a switch), and the like. According to one embodiment of the invention, when a weight (or pressure) sensor or a touch sensor is used to recognize whether the mount target object 210a or 210b is placed on the support unit 120, the sensor may be included in at least one of the support plate 121 and the support member 122, and when an image acquisition module or a scanner module is used, the module may be included in the transport robot 100 or a predetermined structure in a transport place.

A mount pillar 130 may be connected to the support unit 120 and configured to include a mount unit 131 including at least one mount member 131a and/or 131b for mounting the mount target object 210a or 210b. The mount member 131a or 131b may refer to a pair of protrusions that protrude from the mount pillar 130 toward an inner side of the transport robot 100 to support both ends of the mount target object 210a or 210b, thereby mounting the mount target object 210a or 210b (here, 131a and 131b indicate only one of the pair of protrusions, respectively). However, the mount member 131a or 131b does not necessarily have a protruding shape and may have various shapes as long as the objects of the invention may be achieved, and may include various types of mechanical structures for fixing the mount target object 210a or 210b to the mount member 131a or 131b. For example, the mount member 131a or 131b may have a shape that is recessed from the mount pillar 130 toward an outer side of the transport robot 100.

According to one embodiment of the invention, the mount unit 131 may determine whether each mount member 131a or 131b mounts the mount target object 210a or 210b. For example, each mount member 131a or 131b may include a weight (or pressure) sensor and/or a touch sensor, and a control unit 150 for controlling the drive unit 110 and a hold unit 140 to be described below may receive a signal from each mount member 131a or 131b to recognize which mount member 131a or 131b mounts or releases the mount target object 210a or 210b. However, the determination of whether each mount member 131a or 131b mounts the mount target object 210a or 210b is not necessarily performed only by using a weight (or pressure) sensor and/or a touch sensor, but may also be performed using an image acquisition module or a scanner module similarly to the above-described recognition unit (not shown).

Meanwhile, according to one embodiment of the invention, the mount member 131a or 131b may have a property of a magnet (e.g., a permanent magnet or an electromagnet) or a property of reacting to a magnet. In this case, the part of the mount member 131a or 131 b to which the mount target object 210a or 210b is mounted may also have a property of a magnet or a property of reacting to a magnet, so that the mount target object 210a or 210b may be more securely fixed to the mount member 131a or 131b.

The hold unit 140 may be coupled to an outer side of the mount pillar 130 and configured to move vertically along the mount pillar 130. Specifically, the hold unit 140 may move vertically along the outer side of the mount pillar 130 to load the mount target object 210a or 210b to the mount unit 131, and to unload the mount target object 210a or 210b mounted to the mount unit 131.

Further, the hold unit 140 may be configured to extend or retract on a plane including travelable directions of the transport robot 100. Specifically, the hold unit 140 may be configured to include a retractable arm 142 so that the length of the hold unit 140 may be adjusted on the plane including the travelable directions of the transport robot 100. According to one embodiment of the invention, the hold unit 140 may move vertically in a state in which the length of the hold unit 140 is sufficiently increased while holding a mount target object, so that a mount target object mounted to the mount unit 131 may not interfere (i.e., collide) with a mount target object to be newly mounted to the mount unit 131 or to be unloaded from the mount unit 131.

In addition, the hold unit 140 may include an end effector 141 configured to move toward the inner side of the transport robot 100 with respect to the mount pillar 130 and hold the mount target object 210a or 210b, or to move toward the outer side of the transport robot 100 with respect to the mount pillar 130 and release the mount target object 210a or 210b.

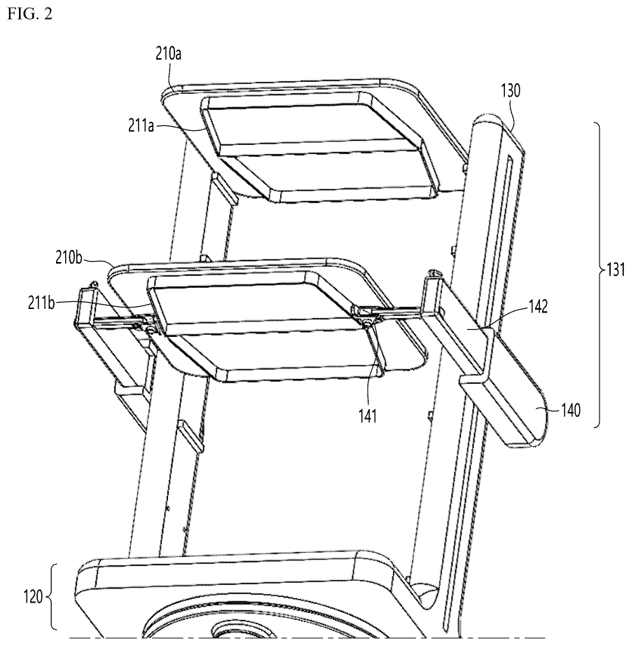

FIG. 2 shows a view of the transport robot 100 shown in FIG. 1 as seen from below.

The mount target object 210a or 210b may include a mount target object-side coupling part 211a or 211b to be held by the end effector 141. According to one embodiment of the invention, the mount target object-side coupling part 211a or 211b may have a point-symmetrical shape. In this case, the mount target object 210a or 210b may be advantageously mounted to the mount unit 131 in both orientations. That is, when a mount target object may be mounted to the mount unit 131 in a specific state, the mount target object may be mounted to a mount member even in a state in which the mount target object is rotated by 180 degrees on the plane including the travelable directions of the transport robot 100.

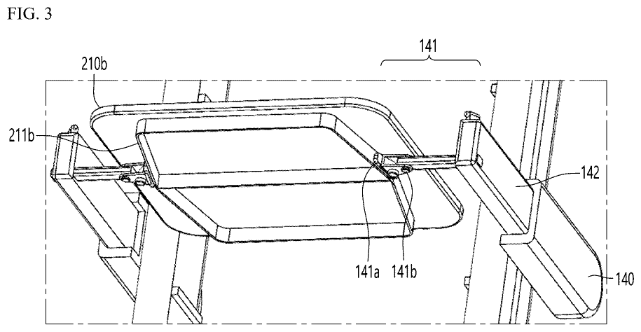

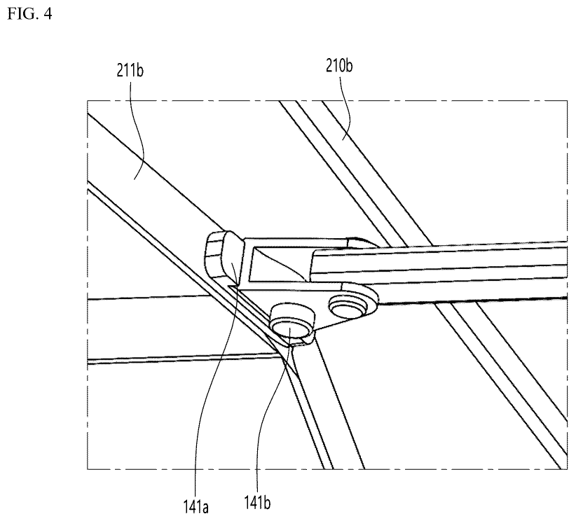

FIG. 3 shows an enlarged view of a part of FIG. 2, and FIG. 4 shows an enlarged view of a part of FIG. 3.

Referring to FIGS. 3 and 4, the mount target object 210b may include the mount target object-side coupling part 211b to be held by the end effector 141, and the end effector 141 may include an end effector-side coupling part 141a for engaging with the mount target object-side coupling part 211b to hold the mount target object 210b. Here, the mount target object-side coupling part 211b and the end effector-side coupling part 141a may have a property of a magnet (e.g., a permanent magnet or an electromagnet) or a property of reacting to a magnet. In this case, when the end effector moves toward the inner side of the transport robot 100 and holds the mount target object 210b, the end effector-side coupling part 141a may engage well with the mount target object-side coupling part 211b even if the end effector-side coupling part 141a and the mount target object-side coupling part 211b are slightly misaligned.

Further, according to one embodiment of the invention, the end effector-side coupling part 141a may include at least one of a pressure sensor (e.g., a pressure sensing film) and a touch sensor (e.g., a touch sensing switch). The sensor may be used to determine whether the end effector-side coupling part 141a and the mount target object-side coupling part 211b are sufficiently well engaged, and stop the movement of the end effector 141 toward the inner side of the transport robot 100 on the basis of the determination.

Referring further to FIGS. 3 and 4, the hold unit 140 may include a proximity sensor 141b for sensing a vertical distance between the end effector 141 and a top surface of a target structure. The proximity sensor 141b may be included in the end effector 141 or the retractable arm 142. Here, the target structure may refer to a location from or to which the transport robot 100 is to load or unload a mount target object. For example, the target structure may be a table in a restaurant or a shelf in a transport place (which may comprise one or more tiers) to which a mount target object is to be unloaded.

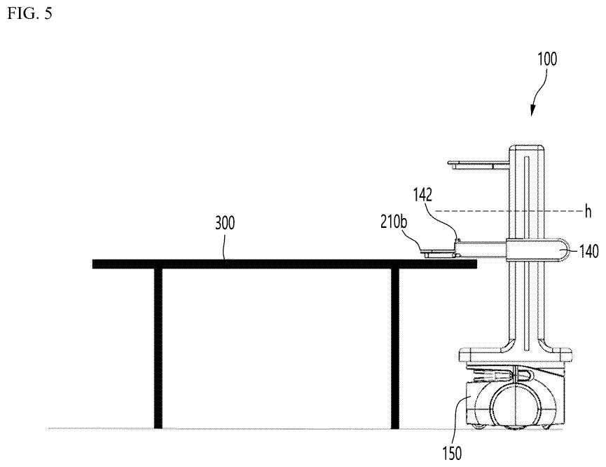

FIG. 5 illustratively shows a view in which the transport robot according to the first embodiment of the invention unloads a mount target object.

The transport robot 100 may move to the vicinity of a table 300 (i.e., a target structure) in order to unload the mount target object 210b. When a height h1 of the table 300 is known to the transport robot 100, the control unit 150 may position the hold unit 140 at an appropriate height h greater than the height of the table 300 in order to unload the mount target object 210b. Next, the control unit 150 may cause the transport robot 100 to move closer to the table 300 in order to unload the mount target object 210b. Next, the control unit 150 may lower the hold unit 140 from the height h to a top surface of the table 300 in order to put down the mount target object 210b on the top surface of the table 300, and the proximity sensor 141b may be used to stop the downward movement of the hold unit 140 (i.e., to determine whether the hold unit 140 is lowered down to the top surface of the table 300). Next, the control unit 150 may move the end effector 141 to the outer side of the transport robot 100 to release the mount target object 210b, and may move the transport robot 100 away from the table 300 or reduce the increased length of the hold unit 140.

Meanwhile, the hold unit 140 may include an obstacle sensor 143 for sensing an obstacle, which is located on the top surface of the target structure 300, at one end of the hold unit 140. The obstacle sensor 143 may comprise an image acquisition module (e.g., a visible light camera or an infrared camera), a scanner module (e.g., a LIDAR sensor), and the like. According to one embodiment of the invention, when an obstacle is found on the top surface of the target structure 300 by the obstacle sensor 143, the control unit 150 may stop increasing the length of the hold unit 140 and notify a nearby user (e.g., a customer or an employee) that the obstacle is found by means of sound or light.

### Second Embodiment

Since a transport robot according to a second embodiment of the invention has many similarities to the above-described transport robot according to the first embodiment of the invention, differences between the transport robot according to the first embodiment and the transport robot according to the second embodiment will be mainly discussed.

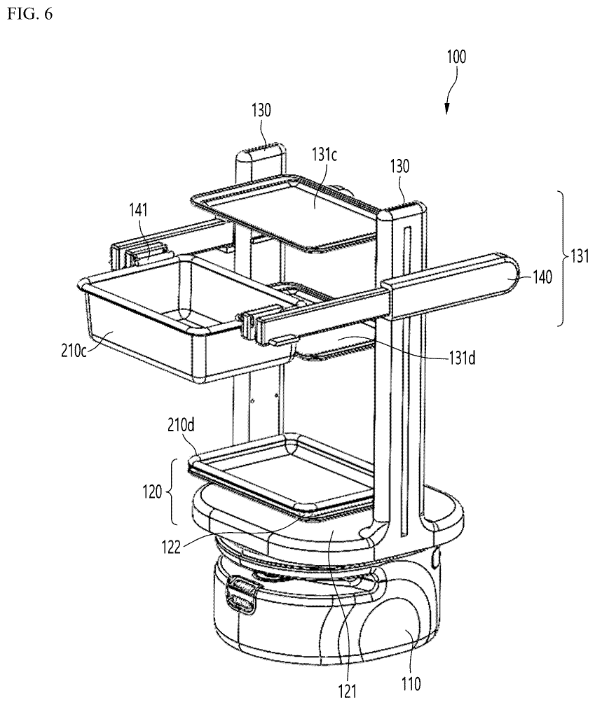

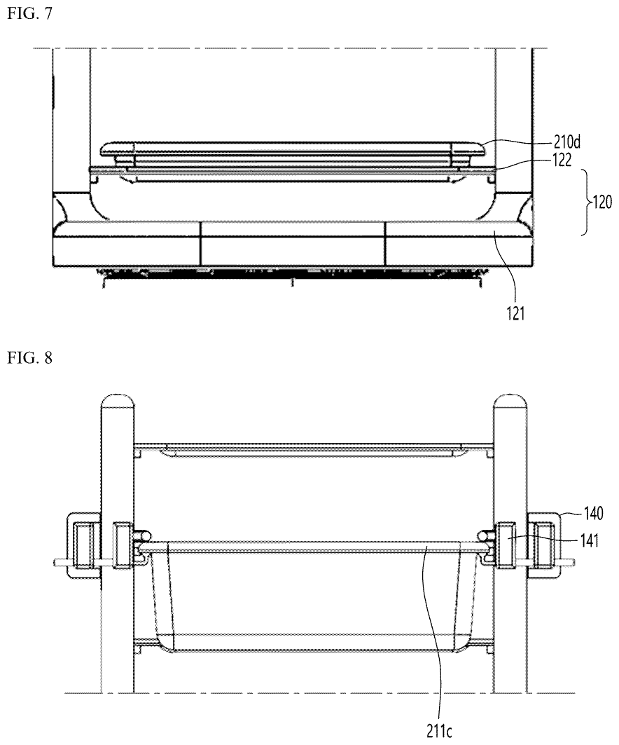

FIG. 6 illustratively shows the transport robot according to the second embodiment of the invention. FIG. 7 illustratively shows a support unit of the transport robot according to the second embodiment of the invention.

Referring to FIGS. 6 and 7, a support unit 120 configured to support a mount target object 210c or 210d for accommodating a transport target object (e.g., a food container) may be disposed above a drive unit 110. A tray-shaped support member 122 for supporting the mount target object 210d may be coupled onto a support plate 121 of the support unit 120.

A recognition unit (not shown) may be configured to recognize whether the mount target object 210c or 210d is placed on the support unit 120, specifically the support member 122. For example, the recognition unit may recognize whether the mount target object 210c or 210d is placed on the support unit 120, specifically the support member 122, using an image acquisition module (e.g., a visible light camera or an infrared camera), a scanner module (e.g., a LIDAR sensor), a weight (or pressure) sensor, a touch sensor (e.g., a switch), and the like. According to one embodiment of the invention, when a weight (or pressure) sensor or a touch sensor is used to recognize whether the mount target object 210c or 210d is placed on the support unit 120, the sensor may be included in the support member 122, and when an image acquisition module or a scanner module is used, the module may be included in the transport robot 100 or a predetermined structure in a transport place.

A mount pillar 130 may be connected to the support unit 120 and configured to include a mount unit 131 including at least one mount member 131c and/or 131d for mounting the mount target object 210c or 210d. The mount member 131c or 131d may be a tray-shaped structure coupled to the mount pillar 130. That is, in contrast to the transport robot according to the first embodiment of the invention, the tray-shaped mount member 131c or 131d is already coupled to the transport robot 100 according to the second embodiment of the invention, and the mount target object 210c or 210d may be placed on a top surface of the tray-shaped mount member 131c or 131d. Since the transport robot 100 according to the second embodiment of the invention already has the tray-shaped mount member 131c or 131d, it may be advantageously used even when there is no need to perform automatic loading/unloading of a mount target object. Meanwhile, in the above case, according to one embodiment of the invention, the central parts of the support member 122 and the mount member 131c or 131d may be recessed in a shape corresponding to the shape of the lower part of the mount target object 210c or 210d in order to securely mount the mount target object 210c or 210d. Of course, the mount member 131c or 131d may have various shapes as long as the objects of the invention may be achieved, and may include various types of mechanical structures for fixing the mount target object 210c or 210d to the mount member 131c or 131d.

FIG. 8 illustratively shows the mount unit of the transport robot according to the second embodiment of the invention.

Referring to FIGS. 6 and 8, a hold unit 140 may include an end effector 141 configured to move toward the inner side of the transport robot 100 and hold the mount target object 210c or 210d, or to move toward the outer side of the transport robot 100 and release the mount target object 210c or 210d. According to one embodiment of the invention, the end effector 141 may include a grab module for grabbing a mount target object-side coupling part 211c.

The various configurations described above in connection with the transport robot 100 according to the first and second embodiments of the invention may be operated in a manner similar to those described above when a mount target object placed on a top surface of a target structure (e.g., a table or a shelf) is loaded. In this case, the transport robot 100 may need to be well aligned with the mount target object on the top surface of the target structure so that the mount target object may be smoothly loaded.

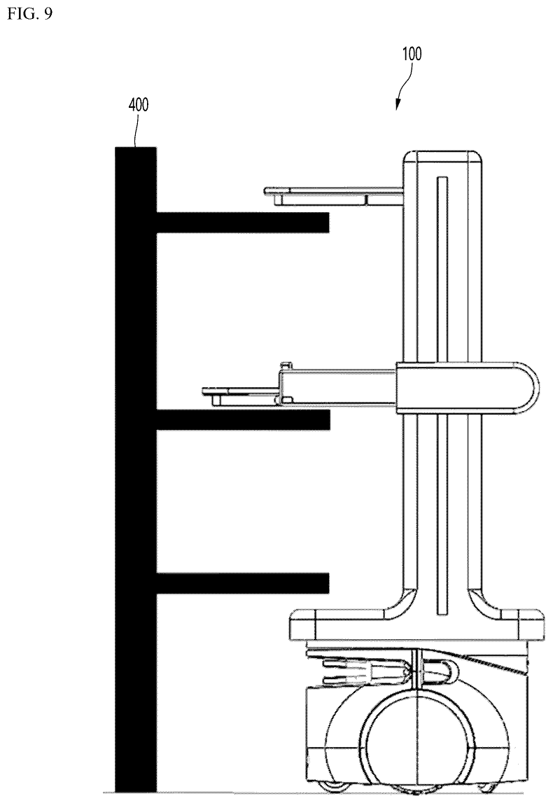

FIG. 9 illustratively shows a view in which the transport robot 100 unloads or loads a mount target object to or from a shelf. As shown in FIG. 9, a shelf 400 may comprise a plurality of tiers. The shelf 400 may be fabricated such that the height of each tier matches the height of each mount member of the transport robot 100 in order for the transport robot 100 to efficiently load/unload a mount target object.

Although the transfer robot 100 has been described above separately with the first and second embodiments of the invention, the first and second embodiments are not mutually exclusive. For example, the transport robot 100 according to the first embodiment of the invention may mount a tub-shaped mount target object, and the end effector of the transport robot 100 according to the first embodiment of the invention may include a grab module for grabbing a mount target object.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A transport robot, comprising:
a drive unit configured to move the transport robot;
a support unit disposed above the drive unit and configured to support a mount target object for accommodating a transport target object;
a mount pillar connected to the support unit and configured to include a mount unit including at least one mount member for mounting the mount target object;
a hold unit connected to an outer side of the mount pillar to move vertically along the mount pillar, and configured to extend or retract on a plane including travelable directions of the transport robot; and
a control unit configured to control the drive unit and the hold unit,
wherein the hold unit includes an end effector configured to move toward an inner side of the transport robot and hold the mount target object, or to move toward an outer side of the transport robot and release the mount target object.

2. The transport robot of claim 1, further comprising a recognition unit configured to recognize whether the mount target object is placed on the support unit.

3. The transport robot of claim 1, wherein the mount unit is configured to be capable of determining whether each of the at least one mount member mounts the mount target object.

4. The transport robot of claim 1, wherein the at least one mount member has a property of a magnet or a property of reacting to a magnet.

5. The transport robot of claim 1, wherein the hold unit is configured to extend or retract by means of a retractable arm.

6. The transport robot of claim 1, wherein the mount target object includes a mount target object-side coupling part to be held by the end effector, and
wherein the mount target object-side coupling part has a point-symmetrical shape.

7. The transport robot of claim 1, wherein the mount target object includes a mount target object-side coupling part to be held by the end effector,
wherein the end effector includes an end effector-side coupling part for engaging with the mount target object-side coupling part to hold the mount target object, and
wherein the mount target object-side coupling part and the end effector-side coupling part have a property of a magnet or a property of reacting to a magnet.

8. The transport robot of claim 1, wherein the mount target object includes a mount target object-side coupling part to be held by the end effector,
wherein the end effector includes an end effector-side coupling part for engaging with the mount target object-side coupling part to hold the mount target object, and
wherein the end effector-side coupling part includes at least one of a pressure sensor and a touch sensor.

9. The transport robot of claim 1, wherein the hold unit includes a proximity sensor for sensing a vertical distance between the end effector and a top surface of a target structure from or to which the mount target object is to be loaded or unloaded.

10. The transport robot of claim 1, wherein the hold unit includes an obstacle sensor for sensing an obstacle, which is located on a top surface of a target structure from or to which the mount target object is to be loaded or unloaded, at one end of the hold unit.
